(19) United States
(12) Patent Application Publication
(10) Pub. No.: US 2019/0139150 A1
(43) Pub. Date: May 9, 2019

(54) SYSTEMS AND METHODS FOR GENERATING MULTI-CONTRIBUTOR CONTENT POSTS FOR EVENTS

(71) Applicant: Facebook, Inc., Menlo Park, CA (US)

(72) Inventors: Ryan Brownhill, San Francisco, CA (US); Sharon Zeng, San Francisco, CA (US); John Henry Trollman, JR., San Francisco, CA (US); Eric Mikael Don Eriksson, San Francisco, CA (US); Amy Sun, San Francisco, CA (US)

(21) Appl. No.: 15/808,638

(22) Filed: Nov. 9, 2017

(51) Int. Cl. G06Q 50/00; G06Q 10/10

(52) U.S. Cl. CPC G06Q 50/01; G06Q 10/1095

(57) ABSTRACT

Systems, methods, and non-transitory computer-readable media can receive event information for an event. A determination can be made that a first user is attending the event. The first user can be provided with access to an event-related content user interface based on the determining that the first user is attending the event. The first user can use the event-related content item user interface to create and submit one or more event-related content items for potential inclusion in an event story associated with the event.

### FIELD OF THE INVENTION

The present technology relates to the field of social networking systems. More particularly, the present technology relates to systems and methods for generating multi-contributor content posts for events.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as stories, status updates, images, videos, articles, and links, via the social networking system.

### SUMMARY

Various embodiments of the present disclosure can include systems, methods, and non-transitory computer readable media configured to receive event information for an event. A determination can be made that a first user is attending the event. The first user can be provided with access to an event-related content user interface based on the determining that the first user is attending the event. The first user can use the event-related content item user interface to create and submit one or more event-related content items for potential inclusion in an event story associated with the event.

In an embodiment, the event story is an ephemeral content post that is accessible for a pre-determined period of time.

In an embodiment, the event story comprises a plurality of event-related content items created and submitted by a plurality of users determined to be attending the event.

In an embodiment, the determining that the first user is attending the event comprises determining that the first user has taken an action on a social networking system indicating that the first user intends to attend the event.

In an embodiment, the determining that the first user is attending the event comprises determining that the first user has obtained tickets for the event.

In an embodiment, the determining that the first user is attending the event is performed based on geo-location information associated with the user.

In an embodiment, the event is associated with a particular time and a particular location, and the geo-location information associated with the user indicates that the user is located at the particular location at the particular time.

In an embodiment, the first user is presented with the event story. The event story comprises a plurality of event-related content items associated with the event.

In an embodiment, the presenting the first user with the event story comprises presenting within the event story one or more event-related content items created by the first user before presenting event-related content items created by other users.

In an embodiment, the plurality of event-related content items are ranked based on user affinity information. The user affinity information is indicative of user affinity between the first user and one or more users that have submitted event-related content items for inclusion in the event story.

Various embodiments of the present disclosure can include systems, methods, and non-transitory computer readable media configured to determine that a first user is attending an event. One or more visual effects associated with the event are identified. The one or more visual effects comprise a default visual effect. The first user is provided with access to an event-related content item user interface based on the determination that the first user is attending the event. The event-related content item user interface implements the default visual effect.

In an embodiment, the event-related content item user interface comprises an event-related camera interface configured to capture at least one of photos or videos.

In an embodiment, the default visual effect comprises a default frame associated with the event.

In an embodiment, the event-related camera interface automatically implements the default frame when the event-related camera interface is initiated.

In an embodiment, the event-related camera interface is initiated based on an indication from the first user that the first user would like to create an event-related content item relating to the event.

In an embodiment, a user input is received from the first user to capture an event-related content item via the event-related camera interface.

In an embodiment, the event-related content item comprises an image or a video captured using the event-related camera interface, and the image or the video is bordered by the default frame.

In an embodiment, the default visual effect comprises a default image filter associated with the event.

In an embodiment, the event-related content item user interface allows the first user to create event-related content items relating to the event and to submit event-related content items relating to the event for potential inclusion in an event story associated with the event.

In an embodiment, users that are not determined to be attending the event are not provided with access to the event-related content item user interface.

Various embodiments of the present disclosure can include systems, methods, and non-transitory computer readable media configured to receive from a first user a selection of an event story associated with an event. A plurality of event-related content items associated with the event story are identified. One or more advertisements are identified for placement within the event story. The event story is populated with at least a subset of the plurality of event-related content items and the one or more advertisements.

In an embodiment, at least a first advertisement of the one or more advertisements is identified for placement within the event story based on a likelihood of the first user to interact with the advertisement.

In an embodiment, at least a first advertisement of the one or more advertisements comprises a call to action.

In an embodiment, the call to action allows the first user to follow an entity on the social networking system via the first advertisement.

In an embodiment, the call to action leads the first user to a purchasing page for making a purchase.

In an embodiment, the event story comprises a plurality of event-related content items relating to the event submitted by a plurality of users attending the event.

In an embodiment, an advertisement is placed within the event story after a pre-determined number of event-related content items.

In an embodiment, the first user selects the event story from a story bar comprising a plurality of stories.

In an embodiment, the story bar comprises at least one advertisement story.

In an embodiment, the event story is an ephemeral content post that is accessible for a pre-determined period of time.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an event stories module, according to an embodiment of the present disclosure.

FIG. 2 illustrates an example event-related content module, according to various embodiments of the present disclosure.

FIG. 3 illustrates an example event story provision module, according to various embodiments of the present disclosure.

FIG. 4A illustrates an example scenario associated with providing event story notifications, according to an embodiment of the present disclosure.

FIG. 4B illustrates an example scenario associated with creating an event-related content item, according to an embodiment of the present disclosure.

FIG. 4C illustrates an example scenario associated with sharing an event-related content item, according to an embodiment of the present disclosure.

FIG. 4D illustrates an example scenario associated with providing event stories in a story bar, according to an embodiment of the present disclosure.

FIG. 4E illustrates an example scenario associated with providing an event story in a news feed post, according to an embodiment of the present disclosure.

FIG. 4F illustrates an example scenario associated with providing an event story on an event page, according to an embodiment of the present disclosure.

FIG. 5A illustrates an example method associated with generating event stories, according to an embodiment of the present disclosure.

FIG. 5B illustrates an example method associated with generating event stories with automatic, default visual effects, according to an embodiment of the present disclosure.

FIG. 5C illustrates an example method associated with monetizing event stories, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Multi-Contributor Content Posts for Events

People use computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as stories, status updates, images, videos, articles, and links, via the social networking system.

Users of a social networking system can be provided with a user interface to view and interact with the social networking system. For example, the user interface may be provided via a mobile application or via a web browser. The user interface can provide users with the ability to create, view, and otherwise interact with content on the social networking system. For example, a user can post his or her own photos and videos to the social networking, and/or view photos and videos posted by other users.

Users of a social networking system may be given opportunities to engage with one another via events. For example, one or more users of a social networking system can create an event on the social networking system. Other users of the social networking system can indicate that they will be attending the event, or that they are interested in the event. Users can post pictures, videos, and/or other content that relate to the event. In this way, the event represents a way for users of a social networking system to engage with one another and share in common experiences and/or interests. However, under conventional approaches, users may not have the opportunity to collectively create content relating to an event. For example, users may have the ability to post individual photos, videos, or other content items, but such content items are posted by an individual user and reflect only that individual's experience of the event. Furthermore, users who wish to view content related to an event may find it difficult to find such content, since individual users may be posting content related to the event in different forums within the social networking system.

An improved approach rooted in computer technology overcomes the foregoing and other disadvantages associated with conventional approaches specifically arising in the realm of computer technology. In general, a user can create an event on a social networking system. An event, as used herein, should be understood to broadly encompass any occurrence or concept that is associated with a particular period of time. In one example, an event can be a physical event that happens at a particular location at a particular time (e.g., a concert or sporting event). However, an event can also be a more general concept that is associated with a particular time-frame, and does not necessarily need to be associated with a physical location. An example of such an event can include Black History Month, which occurs during the month of February, or Christmas, which occurs on December 25. A story associated with the event, i.e., an event story, can be generated. In various embodiments, a story can be an ephemeral content post that is accessible on a social networking system for a finite duration of time, e.g., 24 hours. Users that attend and/or participate in the event can be provided with tools to create content associated with the event. User-generated content associated with the event can be aggregated, and at least a subset of the user-generated content can be selected for inclusion in the event story. In this way, each event story can represent an amalgamation of content related to an event that was generated by a plurality of users who participated in and/or attended the event. Users on the social networking system can view event stories for various events. More details of the present technology are described herein.

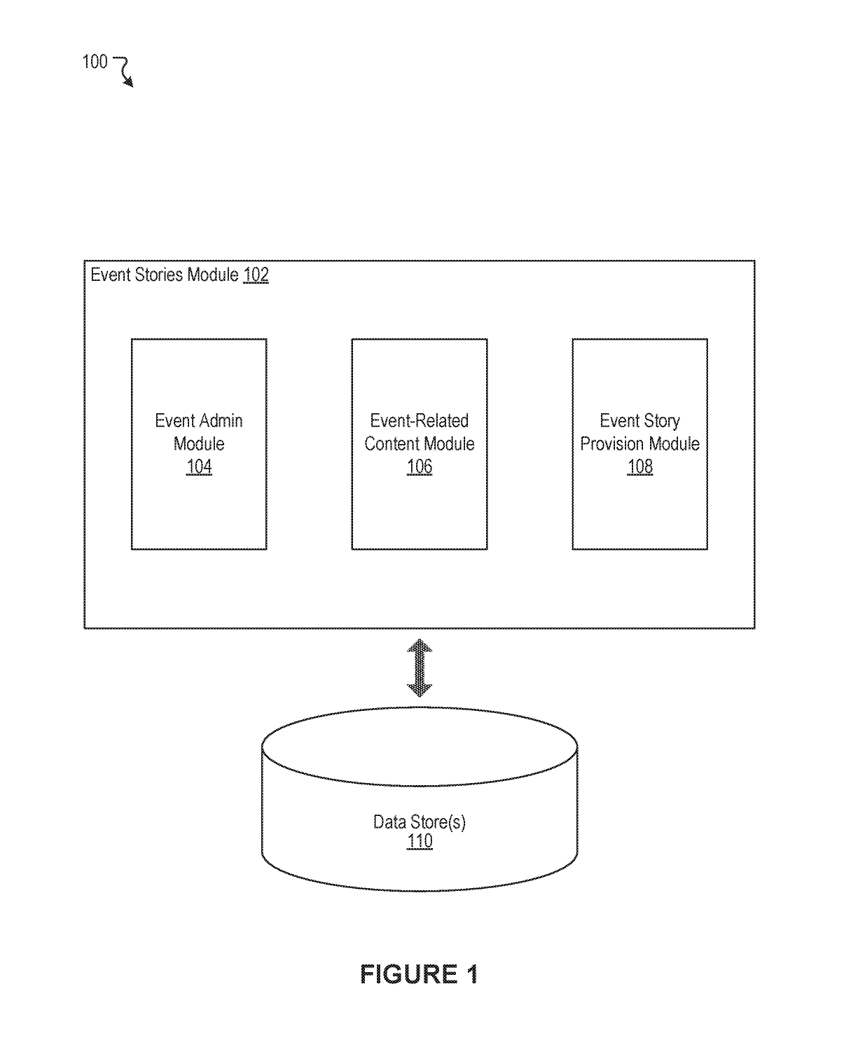

FIG. 1 illustrates an example system 100 including an example event stories module 102, according to an embodiment of the present disclosure. The event stories module 102 can be configured to generate and provide event stories pertaining to one or more events. The event stories module 102 can receive event information associated with an event. The event stories module 102 can create an event story associated with the event. The event stories module 102 can identify a plurality of contributors for the event story. In various embodiments, the plurality of contributors can comprise a plurality of users that are attending the event or otherwise participating in the event. For example, for events that are associated with a physical location, the plurality of contributors can comprise a plurality of users that are physically attending the event. For events that are not associated with a physical location, the plurality of contributors can comprise a plurality of users that are “attending” the event by participating in the event. The event stories module 102 can provide the plurality of contributors with tools to create and share content related to the event. The plurality of contributors can submit content associated with an event, i.e., event-related content, for potential inclusion in the event story for the event.

The event stories module 102 can receive from the plurality of contributors a plurality of event-related content items for the event story. The event stories module 102 can select at least a subset of the plurality of event-related content items to populate the event story. The event stories module 102 can rank the plurality of event-related content items based on ranking criteria and/or filter the plurality of event-related content items based on filtering criteria. The event stories module 102 can populate the event story with one or more event-related content items based on the ranking and/or the filtering. In various embodiments, an event story can be customized for each viewing user. For example, event-related content items for an event can be automatically ranked, filtered, and/or placed in an order within the event story based on user characteristics specific to the viewing user. These features and others will be described in greater detail herein.

As shown in the example of FIG. 1, the event stories module 102 can include an event admin module 104, an event-related content module 106, and an event story provision module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the event stories module 102 can be implemented in any suitable combinations.

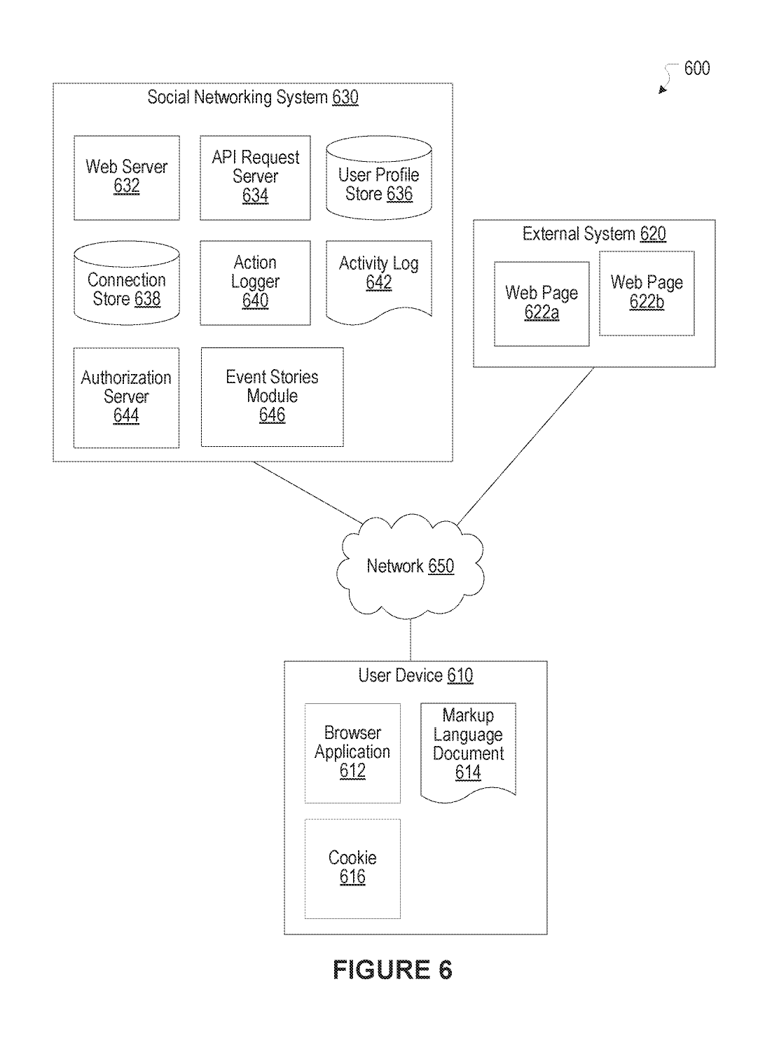

In some embodiments, the event stories module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the event stories module 102 can be, in part or in whole, implemented as software running on one or more computing devices or systems, such as on a server system or a client computing device. In some instances, the event stories module 102 can be, in part or in whole, implemented within or configured to operate in conjunction with or be integrated with a social networking system (or service), such as a social networking system 630 of FIG. 6. Likewise, in some instances, the event stories module 102 can be, in part or in whole, implemented within or configured to operate in conjunction with or be integrated with a client computing device, such as the user device 610 of FIG. 6. For example, the event stories module 102 can be implemented as or within a dedicated application (e.g., app), a program, or an applet running on a user computing device or client computing system. The application incorporating or implementing instructions for performing functionality of the event stories module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The event stories module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social engagements, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the event stories module 102. For example, the data store 110 can store event information associated with a plurality of events, user event attendance information, event-related content items, content item ranking criteria, and the like. It is contemplated that there can be many variations or other possibilities.

The event admin module 104 can be configured to generate an event on a social networking system. As discussed above, an event can be broadly defined as an occurrence or concept that is associated with a particular time. For example, a sporting event is an example of an event that is associated with both a particular time and particular location, whereas holidays (e.g., Thanksgiving, Christmas) or cultural events (e.g., Presidential Elections, Black History Month, etc.) are examples of events that are associated with a particular time without necessarily being associated with a particular location.

In certain embodiments, one or more events may be related to one another. For example, a particular event may be a parent event which has one or more related child events. An example of such an event might include Pride Week, with the parent event being associated with the cultural event “Pride Week,” and child events being associated with individual, location-specific celebrations of Pride Week, e.g., the San Francisco Pride Parade.

The event admin module 104 can be configured to receive event information for an event from one or more users creating the event. The one or more users may be referred to as event administrators or admins. In various embodiments, event information can include a user-selected option of whether or not to generate an event story for the event. In other embodiments, event stories may be automatically generated for every event that occurs on or is known to a social networking system. In various embodiments, event information can include a user-selected option of whether the event is a public event or a private event. In various embodiments, content associated with a public event, including an event story associated with the event, can be publicly available to all users of the social networking system. In various embodiments, content associated with a private event may be available only to those users who are invited to and/or otherwise associated with the event.

The event admin module 104 can be configured to receive event story options from one or more event admins. For example, event admins can specify various restrictions on users that can contribute to an event story for an event. Such restrictions may specify, for example, that only event admins can contribute to the event story, that only a particular set of users can contribute to the event story, or that anyone attending and/or participating in the event can contribute to the event story. In yet another example, event admins can specify that anyone attending and/or participating in the event can submit event-related content items for the event story, but only those event-related content items approved by the event admins can be included in the event story. Numerous combinations are possible.

The event admin module 104 can also be configured to receive visual effects associated with and/or specific to an event. For example, admins for an event can generate one or more frames customized for the event. In another example, admins for an event can generate one or more visual filters customized for the event. The visual effects can be provided to users attending the event to be used in capturing/generating event-related content items relating to the event. For example, a user attending an event can capture a video of the event which is surrounded by a frame associated with the event. The user can then submit the video as an event-related content item for potential inclusion in an event story for the event. In certain embodiments, visual effects associated with an event may be a premium feature such that event admins can be charged a fee in order to have visual effects available for their event/event story. In other embodiments, users attending an event that would like to create event-related content items related to the event can pay a fee in order to have access to visual effects associated with the event. In some embodiments, payment of the fee can be provided through the social networking system, which, in turn, can direct the fee to an appropriate recipient (e.g., event holder, event admin, social networking system, etc.).

In various embodiments, the event admin module 104 can be configured to export some or all event-related content items submitted for an event story. For example, the event admin module 104 can export a video file and/or an image file for each event-related content item or for combinations or subsets of the event-related content items. Event admins can, for example, download the event-related content items for an event, and can create new content using the event-related content items or share the event-related content items.

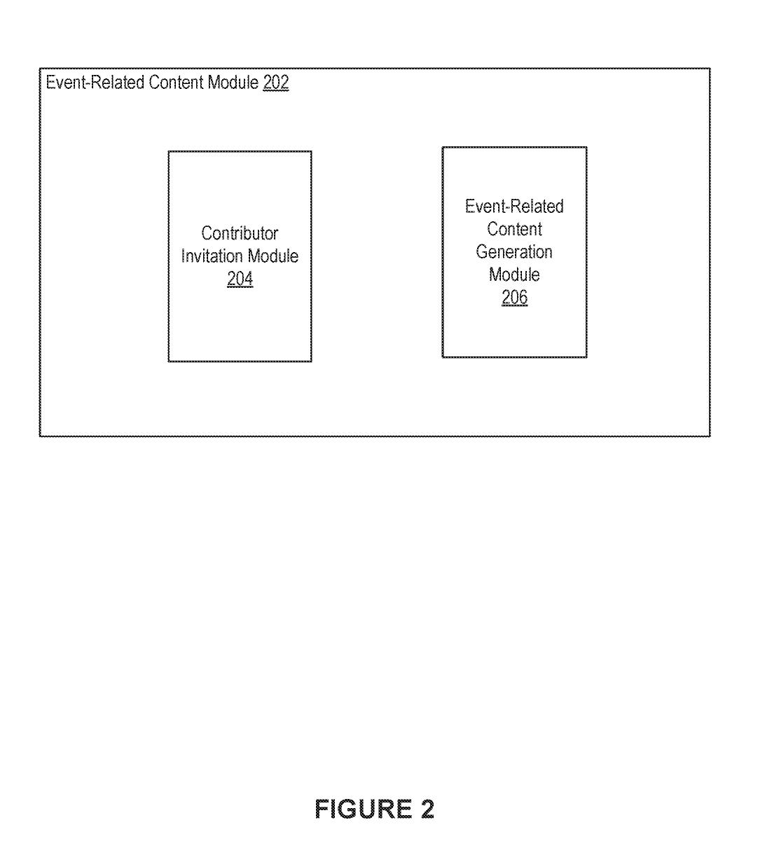

The event-related content module 106 can be configured to receive a plurality of event-related content items for populating an event story associated with an event. The event-related content module 106 can be configured to identify a set of contributors for the event story. In various embodiments, the set of contributors can comprise a plurality of users that have been determined to be attending the event associated with the event story. In various embodiments, the set of contributors can be constrained and/or determined based on event admin preferences. The event-related content module 106 can be configured to provide the set of contributors with the ability to submit event-related content items for potential inclusion in the event story. In some embodiments, users that are not in the set of contributors cannot submit event-related content items for the event story. In various embodiments, users in the set of contributors may be provided with a notification or other selectable option that allows them access to an event-related content user interface within which they can create and share event-related content items for potential inclusion in an event story. The event-related content module 106 is described in greater detail herein with reference to FIG. 2.

The event story provision module 108 can be configured to provide to a viewing user an event story associated with an event. The event story provision module 108 can present and/or make viewing users aware of event stories in various ways. For example, the event story provision module 108 can provide an icon for an event story within a story bar (or story feed) in a user's news feed along with icons for one or more other stories. In another example, the event story provision module 108 can provide the event story on an event page associated with the event. In another example, the event story provision module 108 can publish an event post to a viewing user's news feed and the event post can include a link to access an event story. In yet another example, the event story provision module 108 can generate a notification for a viewing user notifying the viewing user of social networking system activity with regard to an event story. The notification may be configured such that the viewing user can select the notification, or a link within the notification, to access the event story.

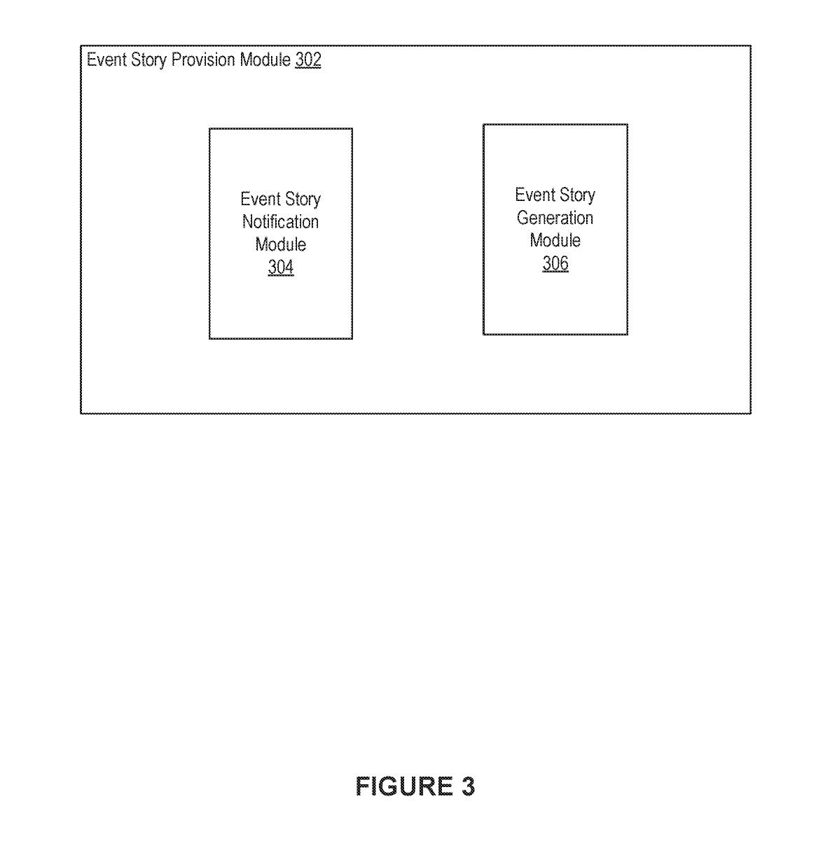

In various embodiments, a viewing user can select an option to view an event story. In order to present the event story to the viewing user, the event story provision module 108 can populate the event story with one or more event-related content items associated with the event story. In various embodiments, the event story provision module 108 can rank a set of event-related content items associated with an event and/or an event story and populate the event story with one or more event-related content items based on the ranking. For example, at least a subset of the set event-related content items may be ordered within the event story based on the ranking. In certain embodiments, the event story provision module 108 can customize the ranking of the set of event-related content items based on user characteristics of the viewing user, such that ordering of event-related content items in the event story is customized for the viewing user. The event story provision module 108 is described in greater detail herein with reference to FIG. 3.

FIG. 2 illustrates an example event-related content module 202 configured to generate event-related content items associated with an event, according to an embodiment of the present disclosure. In some embodiments, the event-related content module 106 of FIG. 1 can be implemented as the event-related content module 202. As shown in the example of FIG. 2, the event-related content module 202 can include a contributor invitation module 204 and an event-related content generation module 206.

The contributor invitation module 204 can be configured to identify a set of contributors for an event story. In certain embodiments, the contributor invitation module 204 can identify the set of contributors for an event story by identifying a set of users that are attending an event associated with the event story. The contributor invitation module 204 can determine that a user is attending an event in various ways. For example, the contributor invitation module 204 can determine that a user is attending an event based on ticket purchase information. In another example, the contributor invitation module 204 can determine that a user is attending an event based on a user-initiated indication on a social networking system that the user intends to attend the event. For instance, the user can select an option on an event page associated with the event indicating that the user will be attending the event. In another instance, the contributor invitation module 204 can determine that a user is attending an event based on a check-in by the user on the social networking system. In yet another example, the contributor invitation module 204 can determine that a user is attending an event based on geo-location information associated with the user and current time information. For instance, if an event is scheduled to take place at a particular location at a particular time, and it is determined that the user is in the particular location at the particular time, a determination can be made that the user is attending the event. User geo-location information can include GPS information from a user's mobile device, geo-fencing information from the user's mobile device, near field communications, low-power Bluetooth beacon communications, or any other indicator and/or source of user location information.

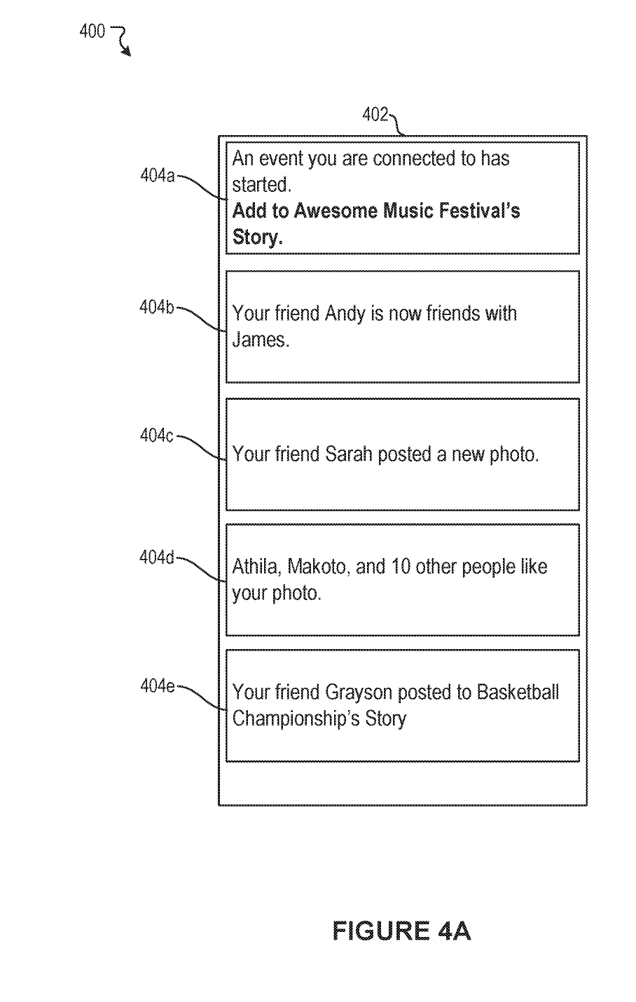

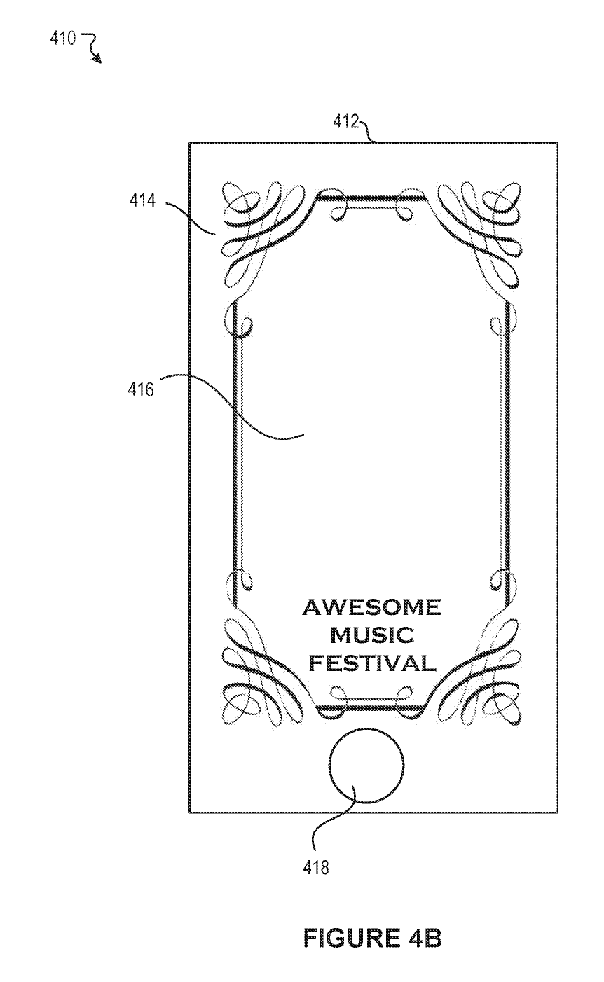

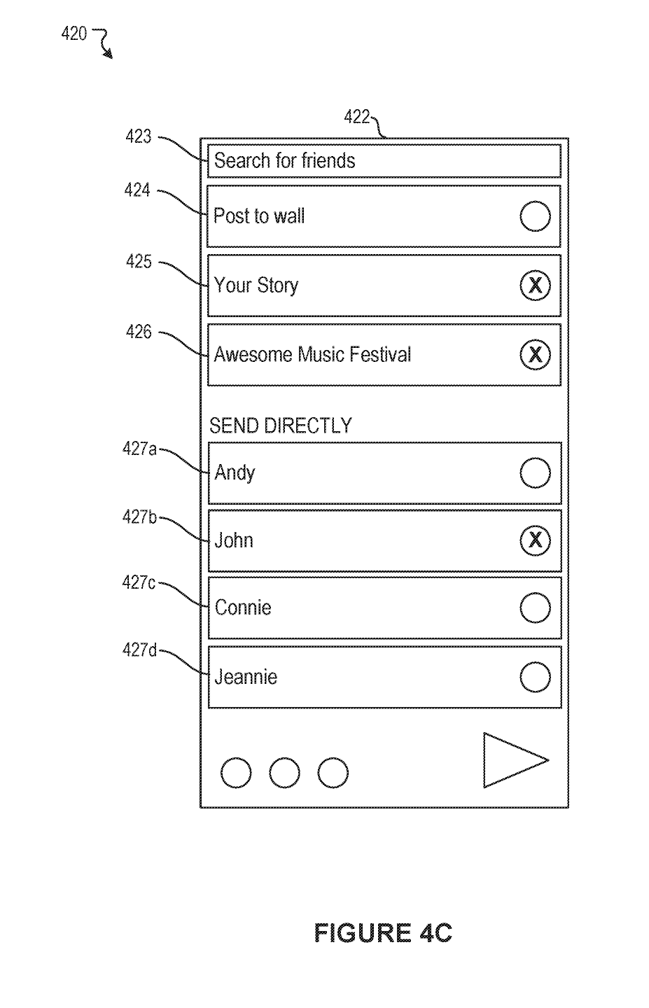

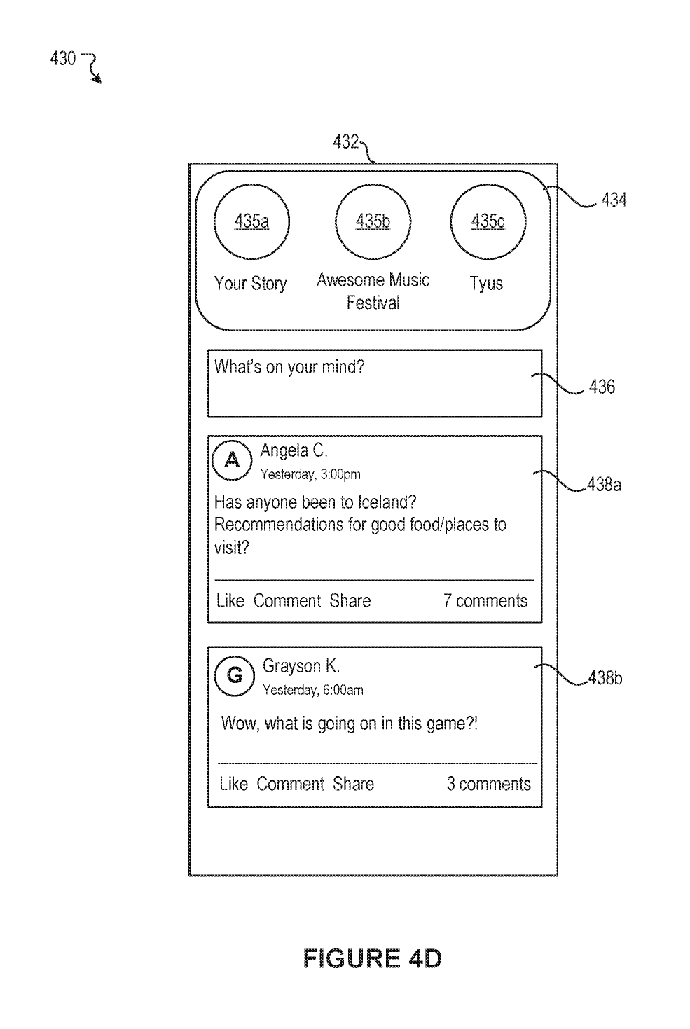

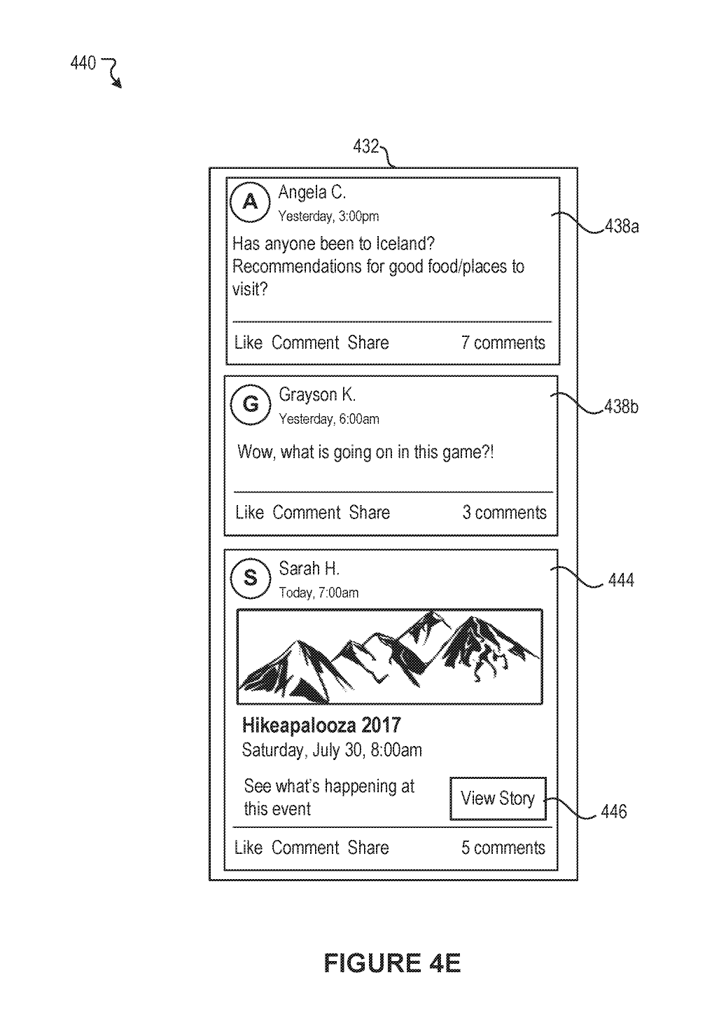

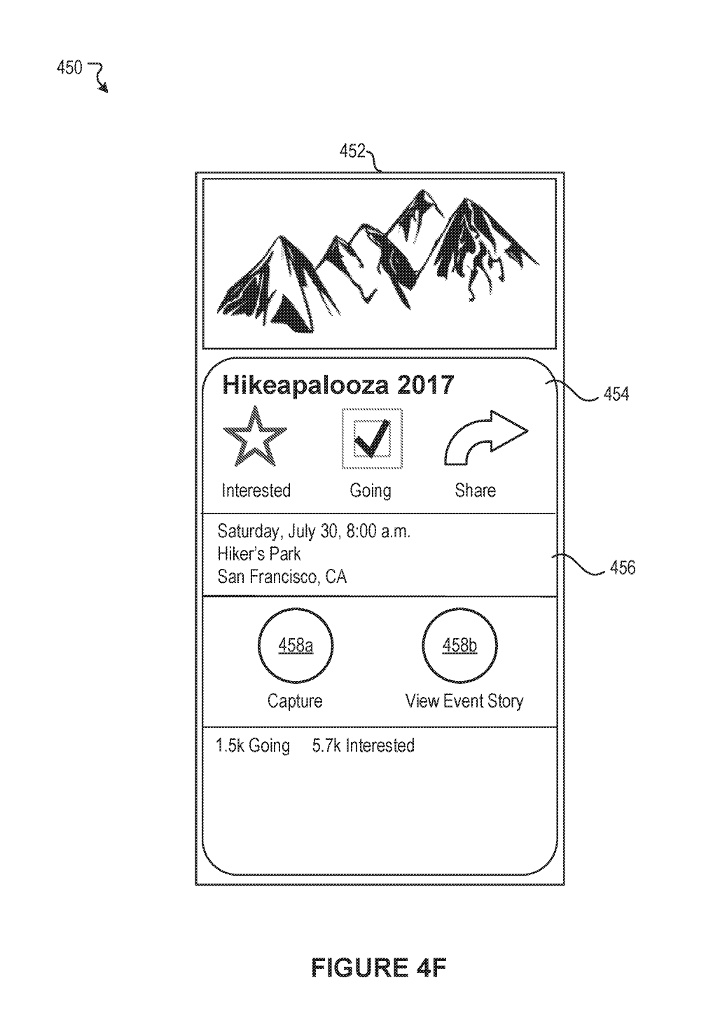

The contributor invitation module 204 can also be configured to invite a set of contributors for an event to create and submit event-related content items for potential inclusion in an event story created for the event. In various embodiments, once a set of contributors has been identified for an event, the contributor invitation module 204 can generate notifications for at least some of contributors notifying them that the event has begun and inviting each contributor to contribute event-related content items to the event story. An example of such a notification is presented in FIG. 4A, described in greater detail below. In various embodiments, based on a determination that a user is attending an event, the contributor invitation module 204 can enable an option and/or a user interface on a user computing device to capture and submit event-related content items for the event story. For example, the contributor invitation module 204 can provide a user that is identified as a contributor to an event (e.g., is determined to be attending the event) with a notification that, when selected by the user, leads the user to an event-related content user interface within which the user can create and submit event-related content items relating to the event. In another example, the contributor invitation module 204 can enable an option on an event page for the event or otherwise enable an option on a user's computing device user interface that, when selected by the user, provides the user with access to the event-related content user interface. Many variations are possible.

The event-related content generation module 206 can be configured to provide an event-related content user interface within which a user can create, submit, and/or share event-related content items for an event. In various embodiments, if a user selects an option to access an event-related content user interface, the user can be taken to an event-related camera interface that enables the user to use a camera on his or her computing device to capture an event-related content item. The user can then submit the event-related content item for potential inclusion in an event story for the event. In various embodiments, the event-related camera interface can include one or more visual effects, such as filters or frames, associated with the event. In various embodiments, users may be given the option to purchase one or more visual effects associated with an event. In these embodiments, if a user purchases a visual effect, the user can utilize the visual effect while capturing an event-related content item and the captured event-related content item will present the visual effect during playback. In certain embodiments, a particular visual effect, such as a particular frame, can be selected as a default visual effect for the event. In such embodiments, when an event-related camera interface is presented to a user, the event-related content generation module 206 can automatically apply the default visual effect to the event-related camera interface. For example, if the default visual effect is a frame created for the event, the event-related camera interface can open on a user's computing device with the default frame already presented in and applied to the event-related camera interface. In various embodiments, a default visual effect may be selected for an event based on a popularity of the visual effect (e.g., how often the visual effect is selected by users). In certain embodiments, users may be able to create and upload their own visual effects for an event.

The event-related content generation module 206 can be configured to allow a user to capture an event-related content item only when certain capture conditions are satisfied. In some embodiments, the capture conditions may include a location condition, such that the user can only create event-related content items for an event story if it is determined that the user is in a location associated with the event/event story. In some embodiments, the capture conditions may include a time condition. For example, a particular event may be scheduled to occur between a start time and an end time. The capture conditions may specify that an event-related content item for that event must be captured between a capture start time and a capture end time. The capture start time may be a pre-determined capture start time and/or may be a certain amount of time prior to the event start time (e.g., six hours before the event start time). Similarly, the capture end time may be pre-determined and/or may be a fixed amount of time after the event end time (e.g., six hours after the event end time).

Once a user has created an event-related content item (e.g., captured a photo or a video, or created a text-based post or a drawing post) for an event, the event-related content generation module 206 can present a share sheet interface within which the user can select where to share the event-related content item. For example, the user can post the event-related content item to his or her own story, i.e., a story consisting of one or more content items posted by the user. The user can also elect to submit the event-related content item for potential inclusion in an event story for the event. In certain embodiments, if the user is participating in a plurality of related events (e.g., a parent event and a child event occurring simultaneously), the user may be given the option to submit the event-related content item to each event story for the plurality of related events. In various embodiments, the user can also elect to share the event-related content item directly to one or more individual users on a social networking system through, for example, an instant message, a direct notification, or an email.

FIG. 3 illustrates an example event story provision module 302 configured to generate, populate, and/or provide an event story to a viewing user, according to an embodiment of the present disclosure. In some embodiments, the event story provision module 108 of FIG. 1 can be implemented as the event story provision module 302. As shown in the example of FIG. 3, the event story provision module 302 can include an event story notification module 304 and an event story generation module 306.

The event story notification module 304 can be configured to notify a viewing user of an event story. In certain embodiments, the event story notification module 304 can be configured to provide a viewing user with a notification of an event story associated with an event if the viewing user has indicated an interest in the event. For example, the viewing user may have selected an option on an event page associated with the event indicating that the viewing user is interested in the event. In such a scenario, the event story notification module 304 may notify the user that an event which the user has expressed an interest in has begun, and provide the user with a link to view the event story for the event. In various embodiments, the notification may be provided within a social networking system notification element or page along with other social networking system notifications (e.g., about the viewing user's connections on the social networking system or other activity on the social networking system). In certain embodiments, the event story notification module 304 can present the event story within a story bar on a viewing user's news feed when the event story becomes available (e.g., once the event has begun, or shortly before the event will begin). A story bar can comprise a plurality of stories, including one or more stories associated with individual users and one or more stories associated with events. The user can select an event story within the story bar to view the event story. In certain embodiments, in addition to stories associated with users and stories associated with events, a story bar can comprise one or more advertisement stories for providing advertisements to viewing users.

In various embodiments, the event story notification module 304 can notify a viewing user of an event story based on a relationship between the viewing user and one or more contributors to the event story. For example, if a viewing user's connection or friend (or close friend) on a social networking system contributed to an event story, the viewing user may receive a notification indicating that the viewing user's friend contributed to an event story. Selecting the notification can lead the viewing user to the event story. In certain embodiments, this notification may be presented in a notification element or page. In other embodiments, the notification may be presented as a content post on a news feed presented to the viewing user. While the notification discussed immediately above was generated based on a user's expressed interest in a particular event, the event story notification module 304 also may generate this type of notification based on a user's interest in a particular user or particular users that have contributed to an event story, as reflected by coefficient values reflecting affinity between the user and the particular user(s) on a social networking system.

The event story notification module 304 can also be configured to notify a viewing user of an event story based on other factors as well. For example, the event story notification module 304 can notify a viewing user of an event story based on a geographic proximity of the viewing user to an event, one or more connections of the user expressing an interest in an event, one or more connections of the user expressing an interest in attending an event, and the like.

The event story generation module 306 can be configured to generate and/or populate an event story for a viewing user. As referenced above, a plurality of contributors can submit event-related content items for potential inclusion in an event story. For example, a plurality of users attending a concert can capture photos and/or videos of the concert, and can submit their photos and/or videos for potential inclusion in an event story associated with the concert. In certain embodiments, the event story generation module 306 can be configured to rank a set of event-related content items associated with an event story based on ranking criteria. Event-related content items can be selected for inclusion in and/or ordered within the event story based on the ranking. For example, a top-ranked event-related content item can be presented first in the event story, a second-ranked event-related content item can be presented second in the event story, and so forth.

In various embodiments, an event story may have a maximum run time. For example, the maximum run time may specify that event stories cannot be longer than 30 minutes. In such embodiments, once an event story reaches the maximum run time, additional event-related content items cannot be added to the event story without first removing one or more event-related content items from the event story.

In various embodiments, the ranking criteria for ranking event-related content items can comprise user affinity information. User affinity information can include a friendship coefficient (or friendship coefficient score) indicative of an affinity between two users. For example, event-related content items that were created and submitted by users that have a high friendship coefficient with the viewing user may be upranked and, accordingly, presented earlier in the event story. In various embodiments, the ranking criteria may comprise a time consideration. For example, it may be preferable for an event story to present event-related content items substantially in chronological order such that a user viewing the event story can see how the event progressed chronologically. Accordingly, the event story generation module 306 can present at least some event-related content items in chronological order.

In various embodiments, the event story generation module 306 can allow event stories to become available shortly before or once an event begins, and can allow event stories to continue to be available/accessible for a period of time after an event. For example, in certain embodiments, an event story may be an ephemeral content post, and can be available for a fixed period of time after the final event-related content item is submitted for the event story. For instance, an event story can be available for twenty-four hours after a final event-related content item has been submitted for the event story. Furthermore, in various embodiments, a submission period for submitting event-related content items may close at a set time before an event ends, once an event ends, or at a set time after an event ends. For example, if a submission period for submitting event-related content items ends 6 hours after an event ends, users can continue submitting event-related content items until the end of the submission period. The event story can continue to be available and accessible for twenty-four hours after the submission of the final event-related content item for the event. It should be appreciated that, given these features, an event story will continue to be updated with additional event-related content items as an event progresses. As such, a ranking of a set of event-related content items submitted for an event story can continuously be updated in substantially real-time as additional event-related content items are submitted for the event story. If a viewing user is viewing an event story “live” as an event progresses, the viewing user can continue to be presented with new event-related content items being submitted to the event story.

In various embodiments, the ranking criteria may uprank a viewing user's own event-related content items submitted to an event story. For example, if the viewing user viewing an event story customized for the viewing user was also a contributor to the event story, the viewing user's event-related content items may be presented first in the event story before any other users' event-related content items. In certain embodiments, for any event-related content items submitted by the viewing user, the viewing user may be shown a number of views for each event-related content item.

In certain embodiments, the event story generation module 306 can be configured to inject advertisements into an event story. For example, after a certain number of event-related content items and/or after a certain amount of time, an advertisement can be presented within the event story. In various embodiments, advertisers can bid for particular ad spots (or placements) within an event story. In certain embodiments, advertisements can include one or more calls to action that allow a viewing user to interact with and/or take action with respect to an advertisement. For example a call to action within an advertisement may prompt a user to follow a particular entity's page on a social networking system. In another example, a call to action within an advertisement may direct a user to a payment page to purchase one or more products or services. In certain embodiments, the call to action may vary based on a status of the event associated with the event story. For example, in various embodiments, as discussed above, a user may be allowed to contribute to an event's event story starting several hours before the event is scheduled to begin until several hours after the event is scheduled to end. Advertisements presented in the event story before the event is scheduled to begin or while the event is taking place may provide viewing users with a call to action to purchase tickets to and/or merchandise for the event. Conversely, advertisements presented in the event story after the event is scheduled to end may remove the call to action to purchase tickets, and include only a call to action to purchase merchandise or other services. In certain embodiments, the event story generation module 306 can be configured to identify advertisements to be placed in an event story based on a viewing user's likelihood to engage with the advertisements. Such likelihood can be determined based on, for example, historical actions of the viewing user in connection with various types of advertisements or a trained machine learning classifier appropriately trained on training data including various user-related and advertisement-related features.

FIG. 4A illustrates an example scenario 400 associated with providing event story notifications, according to an embodiment of the present disclosure. The example scenario 400 includes a notifications user interface 402, which can be displayed as, for example, an element or page. The notifications user interface 402 presents a viewing user with a plurality of notifications 404a-e. A first notification 404a was generated based on the viewing user's expression of interest in a particular event. The first notification 404a indicates that the viewing user has indicated an interest in an event called the “Awesome Music Festival,” and notifies the viewing user that the event has started. The first notification 404a can be selected by the viewing user to view the Awesome Music Festival's event story.

The next three notifications 404b-d are not directed to event stories, and relate to other activities on a social networking system. The second notification 404b notifies the viewing user that the viewing user's friend Andy is now friends with a user named James. The third notification 404c notifies the viewing user that the viewing user's friend Sarah has posted a new photo. The fourth notification 404d notifies the viewing user that various users liked a photo that was posted by the viewing user. In this example, it can be seen that notifications regarding event stories can be placed within a notification element or page along with other types of notifications.

A fifth notification 404e has been generated as a result of a connection of the viewing user contributing to an event story. The fifth notification 404e states that the viewing user's friend, Grayson, posted an event-related content item to the event story for an event called “Basketball Championship.” If the viewing user selects the fifth notification 404e, the viewing user can be presented with the event story for the Basketball Championship event. In certain embodiments, the event-related content item posted by the user Grayson” may be upranked within the event story based on an affinity between the viewing user and Grayson.

FIG. 4B illustrates an example scenario 410 associated with capturing an event-related content item, according to an embodiment of the present disclosure. The example scenario 410 includes an event-related camera user interface 412. The event-related camera user interface 412 allows a user to use a camera on his or her computing device to capture a photo and/or video. The user can submit the photo and/or video as an event-related content item for potential inclusion in an event story. The event-related camera user interface 412 includes a frame 414 that is associated with a particular event, i.e., the Awesome Music Festival. In various embodiments, the frame 414 may be a default visual effect that is automatically applied to the event-related camera interface 412 based on a determination that the user has selected an option to create an event-related content item. The event-related camera user interface 412 includes a live view portion 416 which presents a live view of what is being captured by the user's camera. The event-related camera user interface 412 also includes a capture button 418. A user can, for example, tap the capture button 418 to capture an image, or hold the capture button 418 to capture a video.

FIG. 4C illustrates an example scenario 420 associated with sharing an event-related content item, according to an embodiment of the present disclosure. The example scenario 420 includes a share sheet user interface 422. The share sheet user interface 422 allows a user to select where he or she would like to share an event-related content item that the user has created. The share sheet user interface 422 includes a search bar 423 for the user to search for friends to share the event-related content item with. The share sheet user interface 422 includes a first selectable option 424 to post the event-related content item to the user's wall. The share sheet user interface 422 includes a second selection option 425 to share the event-related content item to the user's own story. The share sheet user interface 422 includes a third selectable option 426 to submit the event-related content item to an event story for the Awesome Music Festival. The share sheet user interface 422 also includes additional selectable options 427a-d to share the event-related content item directly with individual users on a social networking system. In the example scenario 420, the user has opted to share the event-related content item to the user's own story, to the Awesome Music Festival event story, and to a user named John.

FIG. 4D illustrates an example scenario 430 associated with providing event stories in a story bar, according to an embodiment of the present disclosure. The example scenario 430 includes a feed user interface 432. The feed user interface 432 includes a story bar 434, a status input box 436, and content posts 438a and 438b. The story bar 434 comprises a plurality of stories 435a-c. Each story 435a-c can be an ephemeral content post that is available on a social networking system for a pre-determined period of time, e.g., for 24 hours. A viewing user can select a particular story within the story bar 434 to view the story. The story bar 434 includes a first story 435a which is the viewing user's own story, i.e., a story associated with the viewing user. The first story 435a can include one or more content items (e.g., photos, videos) created and shared by the viewing user to his or her story. The story bar 434 includes a second story 435b which is an event story for the Awesome Music Festival. The event story 435b can include, for example, a plurality of event-related content items (e.g., photos and video clips) that attendees of the Awesome Music Festival have created and submitted for inclusion in the Awesome Music Festival event story. The story bar 434 includes a third story 435c which is a story associated with a user named Tyus. The third story 435c can include one or more content items that the user Tyus has created and posted to his story.

FIG. 4E illustrates an example scenario 440 associated with providing event stories in a content post presented within a news feed, according to an embodiment of the present disclosure. The example scenario 440 includes the same feed user interface 432 of FIG. 4D. However, the viewing user has scrolled up in the feed user interface 432 such that the two content posts 438a and 438b have been moved higher within the feed user interface 432, and a new content post 444 has surfaced within the feed user interface 432. The content post 444 is associated with an event called Hikeapalooza 2017, and contains various details about the event, such as an event time. The content post 444 includes a button 446 that a viewing user can select to view an event story associated with the Hikeapalooza event. The event story may include, for example, a plurality of event-related content items that attendees of the event have created and submitted for inclusion in the event story.

FIG. 4F illustrates an example scenario 450 associated with providing event stories via an event page, according to an embodiment of the present disclosure. The example scenario 450 includes an event page interface 452. The event page interface 452 presents an event page that is associated with an event, i.e., Hikeapalooza 2017. The event page interface 452 includes a first portion 454 within which a viewing user can indicate an interest in the event, indicate an intent to attend the event, and/or share the event. The event page interface 452 also includes event information 456 for the event (e.g., time and/or location information). The event page interface 452 includes a capture button 458a to allow a viewing user to capture an event-related content item for the event. In various embodiments, the capture button 458a may have been made available to the viewing user based on a determination that the viewing user is attending the event. The viewing user can select the button 458a to view an event-related camera interface, such as the event-related camera interface shown in FIG. 4B, within which the viewing user can capture an event-related content item for the event. The event page interface 452 also includes a view event story button 458b. The viewing user can select the button 458b to view the event story for the event. In various embodiments, if the viewing user has contributed any event-related content items for the event story, the viewing user's event-related content items can be presented first within the event story.

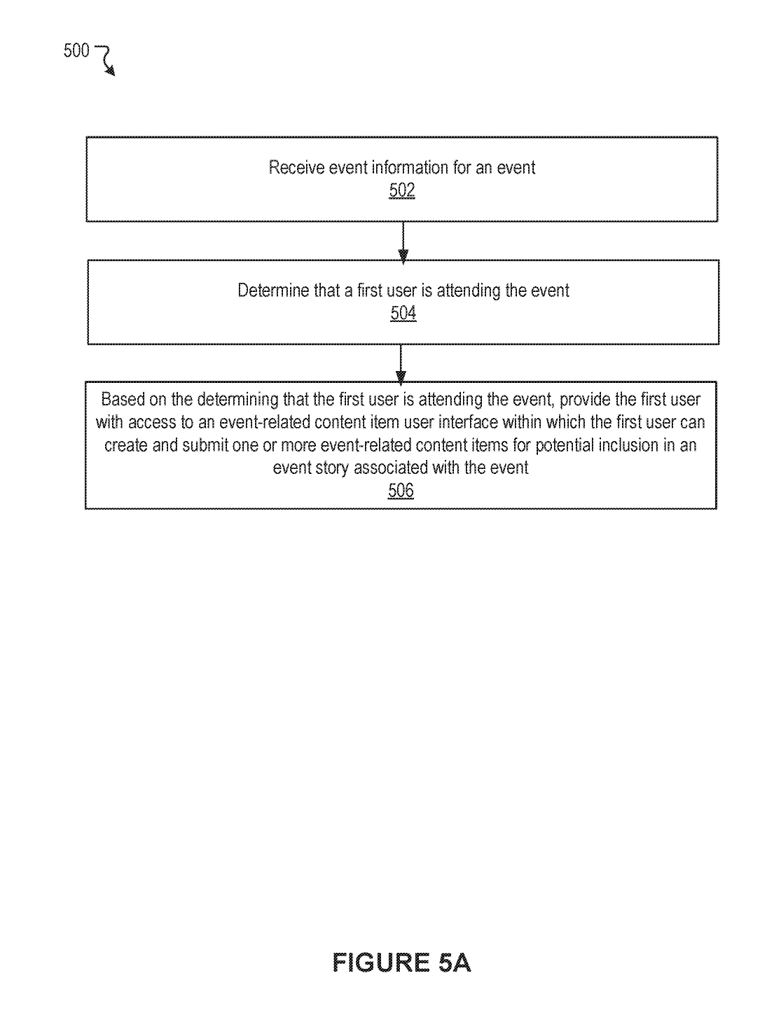

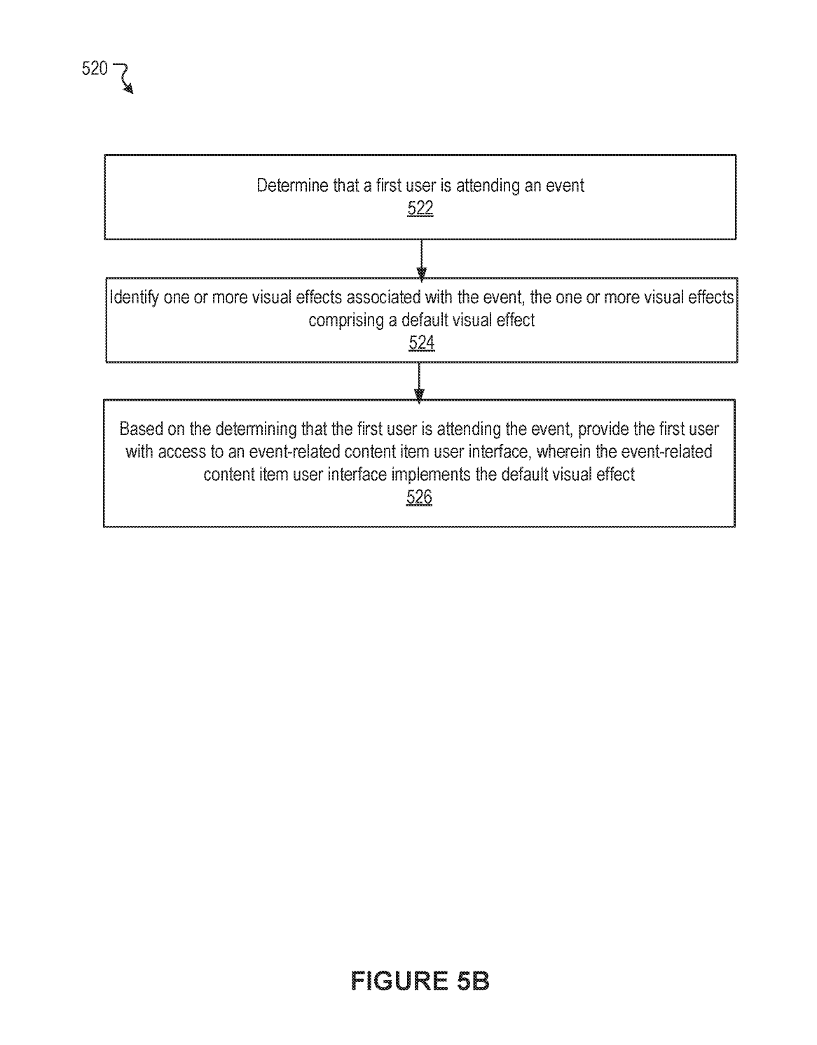

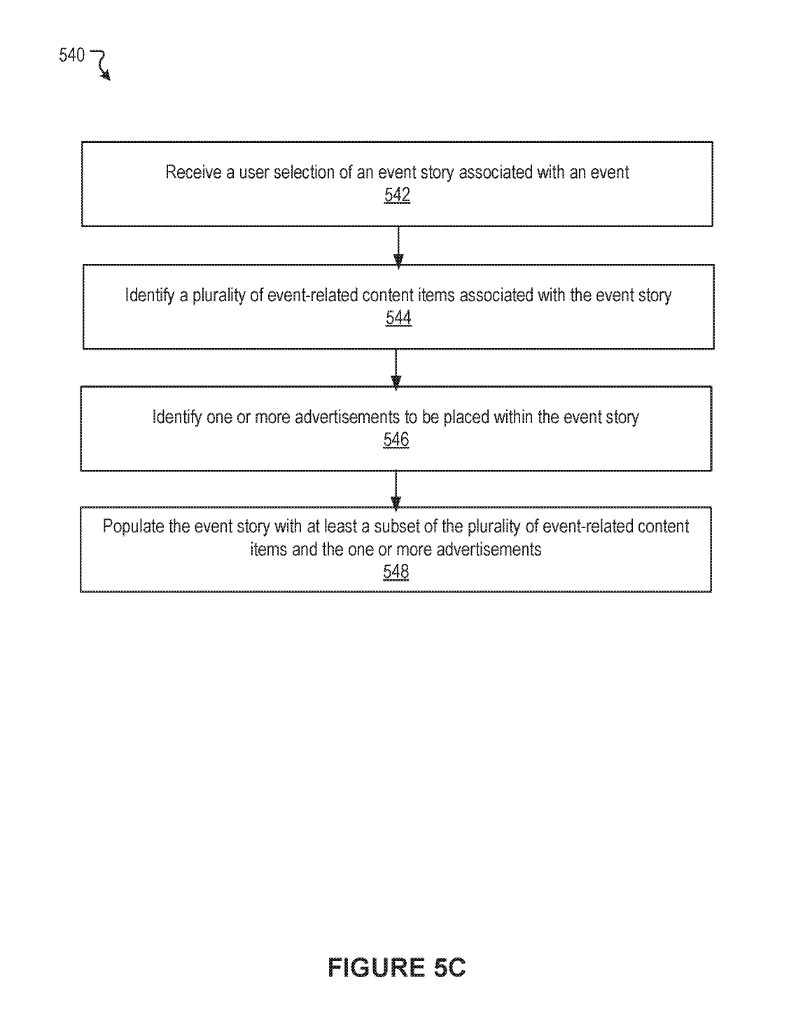

FIG. 5A illustrates an example method 500 associated with generating event stories, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can receive event information for an event. At block 504, the example method 500 can determine that a first user is attending the event. At block 506, the example method 500 can, based on the determining that the first user is attending the event, provide the first user with access to an event-related content item user interface within which the first user can create and submit one or more event-related content items for potential inclusion in an event story associated with the event.

FIG. 5B illustrates an example method 520 associated with automatically providing visual effects associated with an event, according to an embodiment of the present disclosure. It should be appreciated that there can be additional, fewer, or alternative steps performed in similar or alternative orders, or in parallel, within the scope of the various embodiments discussed herein unless otherwise stated.

At block 522, the example method 520 can determine that a first user is attending an event. At block 524, the example method 520 can identify one or more visual effects associated with the effect, the one or more visual effects comprising a default visual effect. At block 506, the example method 520 can, based on the determining that the first user is attending the event, provide the first user with access to an event-related content item user interface, wherein the event-related content item user interface implements the default visual effect.

FIG. 5C illustrates an example method 540 associated with event story monetization, according to an embodiment of the present disclosure. It should be appreciated that there can be additional, fewer, or alternative steps performed in similar or alternative orders, or in parallel, within the scope of the various embodiments discussed herein unless otherwise stated.

At block 542, the example method 540 can receive a user selection of an event story associated with an event. At block 544, the example method 540 can identify a plurality of event-related content items associated with the event story. At block 546, the example method 540 can identify one or more advertisements to be placed within the event story. At block 548, the example method 540 can populate the event story with at least a subset of the plurality of event-related content items and the one or more advertisements.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing engagements between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and engagements with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and engagements.

The social networking system 630 also includes user-generated content, which enhances a user's engagements with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the engagement of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the engagements and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's engagement with an external system 620 from the web server 632. In this example, the external system 620 reports a user's engagement according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing engagements between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include an event stories module 646. The event stories module 646 can, for example, be implemented as the event stories module 102, as discussed in more detail herein. As discussed previously, it should be appreciated that there can be many variations or other possibilities. For example, in some embodiments, one or more functionalities of the event stories module 646 can be implemented in the user device 610.

### Hardware Implementation

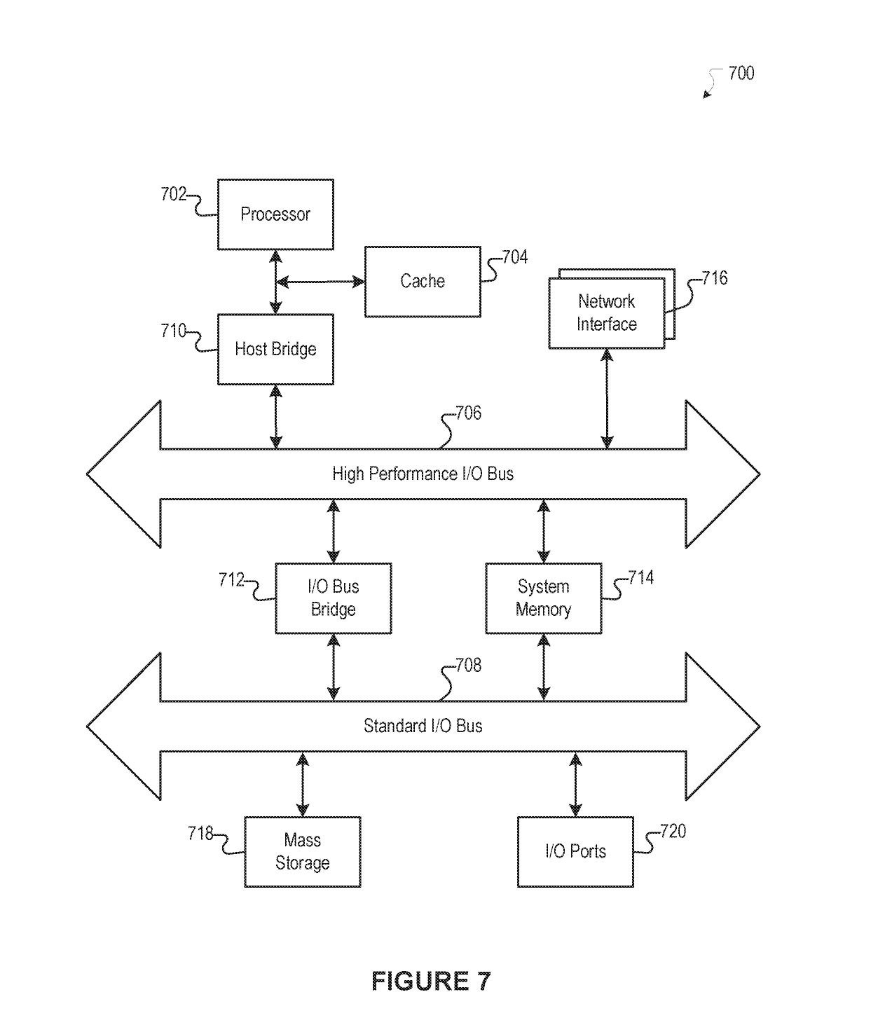

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, event information for an event;
determining, by the computing system, that a first user is attending the event; and
providing, by the computing system, based on the determining that the first user is attending the event, the first user with access to an event-related content item user interface within which the first user can create and submit one or more event-related content items for potential inclusion in an event story associated with the event.

2. The computer-implemented method of claim 1, wherein the event story is an ephemeral content post that is accessible for a pre-determined period of time.

3. The computer-implemented method of claim 1, wherein the event story comprises a plurality of event-related content items created and submitted by a plurality of users determined to be attending the event.

4. The computer-implemented method of claim 1, wherein the determining that the first user is attending the event comprises determining that the first user has taken an action on a social networking system indicating that the first user intends to attend the event.

5. The computer-implemented method of claim 1, wherein the determining that the first user is attending the event comprises determining that the first user has obtained tickets for the event.

6. The computer-implemented method of claim 1, wherein the determining that the first user is attending the event is performed based on geo-location information associated with the user.

7. The computer-implemented method of claim 6, wherein the event is associated with a particular time and a particular location, and the geo-location information associated with the user indicates that the user is located at the particular location at the particular time.

8. The computer-implemented method of claim 1, further comprising presenting the first user with the event story, the event story comprising a plurality of event-related content items associated with the event.

9. The computer-implemented method of claim 8, wherein the presenting the first user with the event story comprises presenting within the event story one or more event-related content items created by the first user before presenting event-related content items created by other users.

10. The computer-implemented method of claim 8, further comprising ranking the plurality of event-related content items based on user affinity information indicative of user affinity between the first user and one or more users that have submitted event-related content items for inclusion in the event story.

11. A system comprising:
at least one processor; and
a memory storing instructions that, when executed by the at least one processor, cause the system to perform a method comprising:
receiving event information for an event;
determining that a first user is attending the event; and
providing, based on the determining that the first user is attending the event, the first user with access to an event-related content item user interface within which the first user can create and submit one or more event-related content items for potential inclusion in an event story associated with the event.

12. The system of claim 11, wherein the event story is an ephemeral content post that is accessible for a pre-determined period of time.

13. The system of claim 11, wherein the event story comprises a plurality of event-related content items created and submitted by a plurality of users determined to be attending the event.

14. The system of claim 11, wherein the determining that the first user is attending the event comprises determining that the first user has taken an action on a social networking system indicating that the first user intends to attend the event.

15. The system of claim 11, wherein the determining that the first user is attending the event comprises determining that the first user has obtained tickets for the event.

16. A non-transitory computer-readable storage medium including instructions that, when executed by at least one processor of a computing system, cause the computing system to perform a method comprising:
receiving event information for an event;
determining that a first user is attending the event; and
providing, based on the determining that the first user is attending the event, the first user with access to an event-related content item user interface within which the first user can create and submit one or more event-related content items for potential inclusion in an event story associated with the event.

17. The non-transitory computer-readable storage medium of claim 16, wherein the event story is an ephemeral content post that is accessible for a pre-determined period of time.

18. The non-transitory computer-readable storage medium of claim 16, wherein the event story comprises a plurality of event-related content items created and submitted by a plurality of users determined to be attending the event.

19. The non-transitory computer-readable storage medium of claim 16, wherein the determining that the first user is attending the event comprises determining that the first user has taken an action on a social networking system indicating that the first user intends to attend the event.

20. The non-transitory computer-readable storage medium of claim 16, wherein the determining that the first user is attending the event comprises determining that the first user has obtained tickets for the event.
